(19) United States
(12) Patent Application Publication
(10) Pub. No.: US 2016/0095039 A1
(43) Pub. Date: Mar. 31, 2016

(54) TRANSMISSION PUNCTURING FOR CO-EXISTENCE ON A SHARED COMMUNICATION MEDIUM

(71) Applicant: QUALCOMM Incorporated, San Diego, CA (US)

(72) Inventors: Nachiappan VALLIAPPAN, San Diego, CA (US); Tamer Adel KADOUS, San Diego, CA (US); Ahmed Kamel SADEK, San Diego, CA (US)

(21) Appl. No.: 14/861,769

(22) Filed: Sep. 22, 2015

Related U.S. Application Data
(60) Provisional application No. 62/057,095, filed on Sep. 29, 2014.
(60) Provisional application No. 62/055,938, filed on Sep. 26, 2014.

(51) Int. Cl. H04W 36/30; H04W 52/04; H04W 36/14; H04W 76/04

(52) U.S. Cl. CPC H04W 36/30; H04W 76/048; H04W 52/04; H04W 36/14

(57) ABSTRACT

Techniques for co-existence on a shared communication medium are disclosed. In one example, transmission in accordance with a first Radio Access Technology (RAT) may be punctured on one or more active periods of a Discontinuous Transmission (DTX) communication pattern based on monitoring of signaling associated with a second RAT. In addition or as an alternative, a transmission power level of an access point for transmission in accordance with a first RAT may be reduced based on one or more signal timing characteristics of signaling associated with a second RAT.

### CROSS-REFERENCE TO RELATED APPLICATIONS

The present application for patent claims the benefit of U.S. Provisional Application No. 62/055,938, entitled “Channel Blocking Interference Management in Unlicensed Spectrum,” filed Sep. 26, 2014, and U.S. Provisional Application No. 62/057,095, entitled “Carrier Sense Adaptive Transmission (CSAT) Management in Unlicensed Spectrum,” filed Sep. 29, 2014, assigned to the assignee hereof, and expressly incorporated herein by reference in its entirety.

### REFERENCE TO CO-PENDING APPLICATIONS FOR PATENT

The present application for patent is also related to the following co-pending U.S. patent application: “Transmission Power Reduction for Co-Existence on a Shared Communication Medium,” having Attorney Docket No. 147228U2, filed concurrently herewith, assigned to the assignee hereof, and expressly incorporated herein by reference in its entirety.

### INTRODUCTION

Aspects of this disclosure relate generally to telecommunications, and more particularly to co-existence on a shared communication medium and the like.

Wireless communication systems are widely deployed to provide various types of communication content, such as voice, data, multimedia, and so on. Typical wireless communication systems are multiple-access systems capable of supporting communication with multiple users by sharing available system resources (e.g., bandwidth, transmit power, etc.). Examples of such multiple-access systems include Code Division Multiple Access (CDMA) systems, Time Division Multiple Access (TDMA) systems, Frequency Division Multiple Access (FDMA) systems, Orthogonal Frequency Division Multiple Access (OFDMA) systems, and others. These systems are often deployed in conformity with specifications such as Long Term Evolution (LTE) provided by the Third Generation Partnership Project (3GPP), Ultra Mobile Broadband (UMB) and Evolution Data Optimized (EV-DO) provided by the Third Generation Partnership Project 2 (3GPP2), 802.11 provided by the Institute of Electrical and Electronics Engineers (IEEE), etc.

In cellular networks, “macro cell” access points provide connectivity and coverage to a large number of users over a certain geographical area. A macro network deployment is carefully planned, designed, and implemented to offer good coverage over the geographical region. To improve indoor or other specific geographic coverage, such as for residential homes and office buildings, additional “small cell,” typically low-power access points have recently begun to be deployed to supplement conventional macro networks. Small cell access points may also provide incremental capacity growth, richer user experience, and so on.

Small cell LTE operations, for example, have been extended into the unlicensed frequency spectrum such as the Unlicensed National Information Infrastructure (U-NII) band used by Wireless Local Area Network (WLAN) technologies. This extension of small cell LTE operation is designed to increase spectral efficiency and hence capacity of the LTE system. However, it may also encroach on the operations of other Radio Access Technologies (RATs) that typically utilize the same unlicensed bands, most notably IEEE 802.11x WLAN technologies generally referred to as “Wi-Fi.”

### SUMMARY

The following summary is an overview provided solely to aid in the description of various aspects of the disclosure and is provided solely for illustration of the aspects and not limitation thereof.

In one example, a communication method is disclosed. The method may include, for example, cycling operation of a first Radio Access Technology (RAT) between active periods and inactive periods of transmission, on a communication medium shared with a second RAT, in accordance with a Discontinuous Transmission (DTX) communication pattern; monitoring second RAT signaling on the communication medium; and puncturing transmission in accordance with the first RAT on one or more of the active periods of the DTX communication pattern based on the monitoring.

In another example, a communication apparatus is disclosed. The apparatus may include, for example, a first transceiver, a second transceiver, at least one processor, and at least one memory coupled to the at least one processor. The first transceiver may be configured to cycle operation of a first RAT between active periods and inactive periods of transmission, on a communication medium shared with a second RAT, in accordance with a DTX communication pattern. The second transceiver may be configured to monitor second RAT signaling on the communication medium. The at least one processor and the at least one memory may be configured to puncture transmission in accordance with the first RAT on one or more of the active periods of the DTX communication pattern based on the monitoring.

In another example, another communication apparatus is disclosed. The apparatus may include, for example, means for cycling operation of a first RAT between active periods and inactive periods of transmission, on a communication medium shared with a second RAT, in accordance with a DTX communication pattern; means for monitoring second RAT signaling on the communication medium; and means for puncturing transmission in accordance with the first RAT on one or more of the active periods of the DTX communication pattern based on the monitoring.

In another example, a transitory or non-transitory computer-readable medium is disclosed. The computer-readable medium may include, for example, code for cycling operation of a first RAT between active periods and inactive periods of transmission, on a communication medium shared with a second RAT, in accordance with a DTX communication pattern; code for monitoring second RAT signaling on the communication medium; and code for puncturing transmission in accordance with the first RAT on one or more of the active periods of the DTX communication pattern based on the monitoring.

In another example, another communication method is disclosed. The method may include, for example, transmitting a first signal at a first transmission power level and in accordance with a first RAT on a communication medium shared with a second RAT; monitoring second RAT signaling on the communication medium for one or more signal timing characteristics; reducing the first transmission power level to a second transmission power level based on the one or more signal timing characteristics; and transmitting a second signal at the second transmission power level and in accordance with the first RAT on the communication medium.

In another example, another communication apparatus is disclosed. The apparatus may include, for example, a first transceiver, a second transceiver, at least one processor, and at least one memory coupled to the at least one processor. The first transceiver may be configured to transmit a first signal at a first transmission power level and in accordance with a first RAT on a communication medium shared with a second RAT. The second transceiver may be configured to monitor second RAT signaling on the communication medium for one or more signal timing characteristics. The at least one processor and the at least one memory may be configured to reduce the first transmission power level to a second transmission power level based on the one or more signal timing characteristics. The first transceiver may be further configured to transmit a second signal at the second transmission power level and in accordance with the first RAT on the communication medium.

In another example, another communication apparatus is disclosed. The apparatus may include, for example, means for transmitting a first signal at a first transmission power level and in accordance with a first RAT on a communication medium shared with a second RAT; means for monitoring second RAT signaling on the communication medium for one or more signal timing characteristics; means for reducing the first transmission power level to a second transmission power level based on the one or more signal timing characteristics; and means for transmitting a second signal at the second transmission power level and in accordance with the first RAT on the communication medium.

In another example, another transitory or non-transitory computer-readable medium is disclosed. The computer-readable medium may include, for example, code for transmitting a first signal at a first transmission power level and in accordance with a first RAT on a communication medium shared with a second RAT; code for monitoring second RAT signaling on the communication medium for one or more signal timing characteristics; code for reducing the first transmission power level to a second transmission power level based on the one or more signal timing characteristics; and code for transmitting a second signal at the second transmission power level and in accordance with the first RAT on the communication medium.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example wireless communication system including an access point in communication with an access terminal.

FIG. 2 is a system-level diagram illustrating contention between Radio Access Technologies (RATs) on a shared communication medium.

FIG. 3 illustrates certain aspects of an example Discontinuous Transmission (DTX) communication scheme.

FIG. 4 illustrates additional aspects of a DTX communication scheme and shows what is referred to herein as puncturing.

FIG. 5 illustrates several example puncturing patterns that may be employed.

FIG. 6 is a resource map diagram illustrating an example data channel muting subframe format for use in subframe puncturing.

FIG. 7 is a resource map diagram illustrating an example broadcast channel blanking subframe format for use in subframe puncturing.

FIG. 8 illustrates an example traffic packet showing select header information for identifying low-latency traffic.

FIG. 9 is a statistical distribution illustrating a mapping between different packet characteristics for a given flow and their correspondence to latency-sensitive traffic.

FIG. 10 illustrates an example of transmission power modification in the context of a DTX communication scheme.

FIG. 11 illustrates an example transmission power reduction scheme.

FIG. 12 is a signaling flow diagram illustrating another example transmission power reduction scheme.

FIG. 13 is a signaling flow diagram illustrating another example transmission power reduction scheme.

FIG. 14 is a signaling flow diagram illustrating another example transmission power reduction scheme.

FIG. 15 illustrates an example of two fixed DTX communication schemes that may be employed upon detection of certain priority triggers.

FIG. 16 is a flow diagram illustrating an example method of communication in accordance with the techniques described herein.

FIG. 17 is a flow diagram illustrating another example method of communication in accordance with the techniques described herein.

FIG. 18 illustrates an example apparatus represented as a series of interrelated functional modules.

FIG. 19 illustrates another example apparatus represented as a series of interrelated functional modules.

### DETAILED DESCRIPTION

The present disclosure relates generally to co-existence techniques for operation on a shared communication medium. To better accommodate certain operations of other Radio Access Technologies (RATs) on the shared communication medium, an access point implementing a Discontinuous Transmission (DTX) communication scheme of active and inactive periods may puncture transmission on one or more of the active periods to introduce additional transmission gaps. The additional transmission gaps may provide more frequent opportunities for another RAT to access the shared communication medium for sending low-latency traffic, for when interference is relatively high (e.g., above a backoff threshold), and so on. In addition or as an alternative, the access point may also reduce its transmission power level based on various signal timing characteristics indicative of the signaling energy of its transmissions being perceived at above a backoff threshold defined by another RAT for controlling access to the shared communication medium.

More specific aspects of the disclosure are provided in the following description and related drawings directed to various examples provided for illustration purposes. Alternate aspects may be devised without departing from the scope of the disclosure. Additionally, well-known aspects of the disclosure may not be described in detail or may be omitted so as not to obscure more relevant details.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., Application Specific Integrated Circuits (ASICs)), by program instructions being executed by one or more processors, or by a combination of both. In addition, for each of the aspects described herein, the corresponding form of any such aspect may be implemented as, for example, “logic configured to” perform the described action.

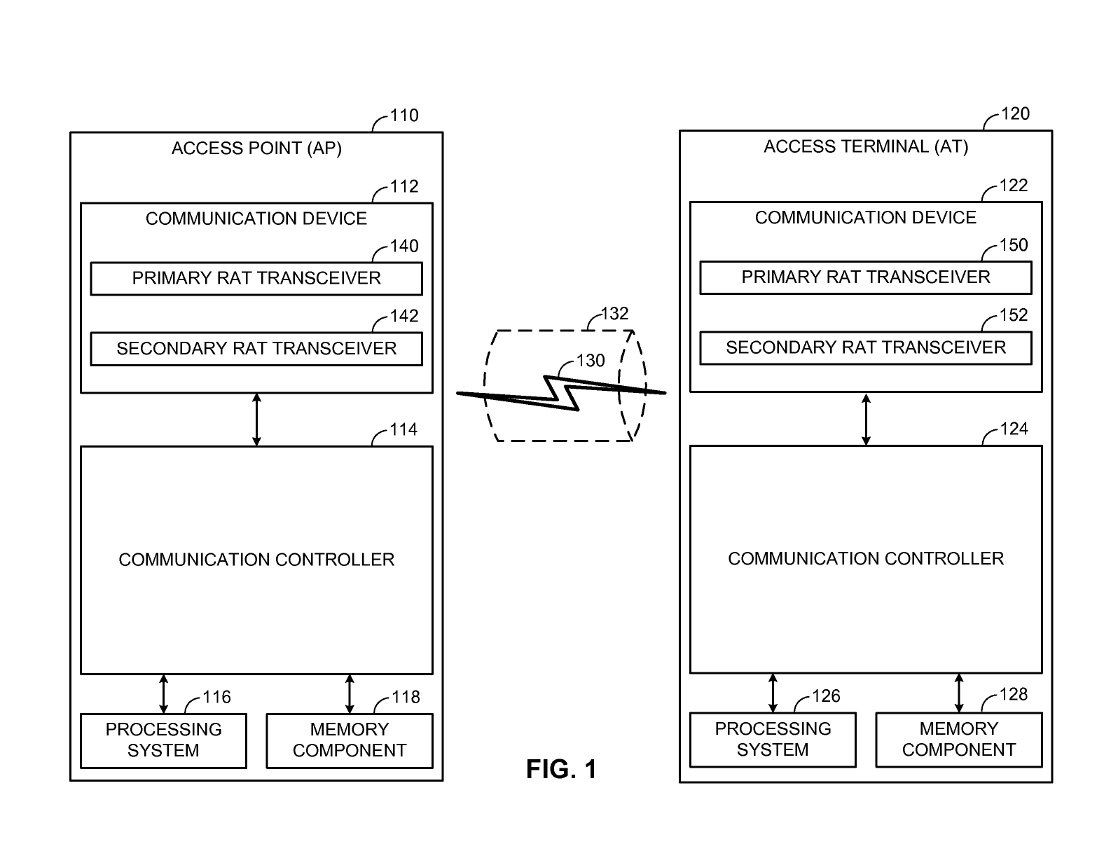

FIG. 1 illustrates an example wireless communication system including an access point in communication with an access terminal Unless otherwise noted, the terms “access terminal” and “access point” are not intended to be specific or limited to any particular Radio Access Technology (RAT). In general, access terminals may be any wireless communication device allowing a user to communicate over a communications network (e.g., a mobile phone, router, personal computer, server, entertainment device, Internet of Things (JOT)/Internet of Everything (JOE) capable device, in-vehicle communication device, etc.), and may be alternatively referred to in different RAT environments as a User Device (UD), a Mobile Station (MS), a Subscriber Station (STA), a User Equipment (UE), etc. Similarly, an access point may operate according to one or several RATs in communicating with access terminals depending on the network in which the access point is deployed, and may be alternatively referred to as a Base Station (BS), a Network Node, a NodeB, an evolved NodeB (eNB), etc. Such an access point may correspond to a small cell access point, for example. “Small cells” generally refer to a class of low-powered access points that may include or be otherwise referred to as femto cells, pico cells, micro cells, Wireless Local Area Network (WLAN) access points, other small coverage area access points, etc. Small cells may be deployed to supplement macro cell coverage, which may cover a few blocks within a neighborhood or several square miles in a rural environment, thereby leading to improved signaling, incremental capacity growth, richer user experience, and so on.

In the example of FIG. 1, the access point 110 and the access terminal 120 each generally include a wireless communication device (represented by the communication devices 112 and 122) for communicating with other network nodes via at least one designated RAT. The communication devices 112 and 122 may be variously configured for transmitting and encoding signals (e.g., messages, indications, information, and so on), and, conversely, for receiving and decoding signals (e.g., messages, indications, information, pilots, and so on) in accordance with the designated RAT. The access point 110 and the access terminal 120 may also each generally include a communication controller (represented by the communication controllers 114 and 124) for controlling operation of their respective communication devices 112 and 122 (e.g., directing, modifying, enabling, disabling, etc.). The communication controllers 114 and 124 may operate at the direction of or otherwise in conjunction with respective host system functionality (illustrated as the processing systems 116 and 126 and the memory components 118 and 128 coupled to the processing systems 116 and 126, respectively, and configured to store data, instructions, or a combination thereof, either as on-board cache memory, separate components, a combination, etc.). In some designs, the communication controllers 114 and 124 may be partly or wholly subsumed by the respective host system functionality.

Turning to the illustrated communication in more detail, the access terminal 120 may transmit and receive messages via a wireless link 130 with the access point 110, the message including information related to various types of communication (e.g., voice, data, multimedia services, associated control signaling, etc.). The wireless link 130 may operate as part of a cell, including Primary Cells (PCells) and Secondary Cells (SCells), on respective component carriers (respective frequencies). The wireless link 130 may operate over a communication medium of interest that includes the component carriers, shown by way of example in FIG. 1 as the communication medium 132, which may be shared with other communications as well as other RATs. A medium of this type may be composed of one or more frequency, time, and/or space communication resources (e.g., encompassing one or more channels across one or more carriers) associated with communication between one or more transmitter/receiver pairs, such as the access point 110 and the access terminal 120 for the communication medium 132.

As an example, the communication medium 132 may correspond to at least a portion of an unlicensed frequency band shared with other RATs. In general, the access point 110 and the access terminal 120 may operate via the wireless link 130 according to one or more RATs depending on the network in which they are deployed. These networks may include, for example, different variants of Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, and so on. Although different licensed frequency bands have been reserved for such communications (e.g., by a government entity such as the Federal Communications Commission (FCC) in the United States), certain communication networks, in particular those employing small cell access points, have extended operation into unlicensed frequency bands such as the Unlicensed National Information Infrastructure (U-NII) band used by WLAN technologies, most notably IEEE 802.11x WLAN technologies generally referred to as “Wi-Fi.”

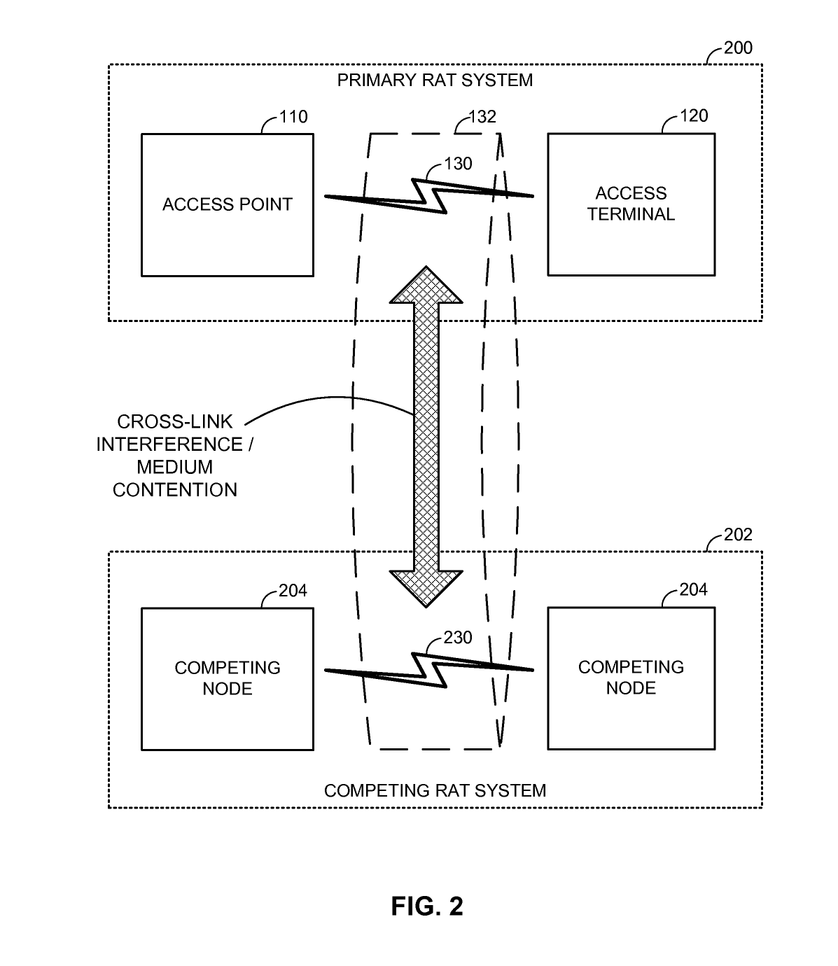

FIG. 2 is a system-level diagram illustrating contention between RATs on a shared communication medium such as the communication medium 132. In this example, the communication medium 132 is used for communication between the access point 110 and the access terminal 120 (representing at least part of a primary RAT system 200) and is shared with a competing RAT system 202. The competing RAT system 202 may include one or more competing nodes 204 that communicate with each other over a respective wireless link 230 also on the communication medium 132. As an example, the access point 110 and the access terminal 120 may communicate via the wireless link 130 in accordance with Long Term Evolution (LTE) technology, while the competing RAT system 202 may communicate via the wireless link 230 in accordance with Wi-Fi technology.

As shown, due to the shared use of the communication medium 132, there is the potential for cross-link interference between the wireless link 130 and the wireless link 230. Further, some RATs and some jurisdictions may require contention or “Listen Before Talk (LBT)” for access to the communication medium 132. As an example, the Wi-Fi IEEE 802.11 protocol family of standards provides a Carrier Sense Multiple Access/Collision Avoidance (CSMA/CA) protocol in which each Wi-Fi device verifies via medium sensing the absence of other traffic on a shared medium before seizing (and in some cases reserving) the medium for its own transmissions. As another example, the European Telecommunications Standards Institute (ETSI) mandates contention for all devices regardless of their RAT on certain communication mediums such as unlicensed frequency bands.

As described in more detail below, the access point 110 and/or the access terminal 120 may mitigate their interference to and from the competing RAT system 202 in different ways.

Returning to the example of FIG. 1, the communication device 112 of the access point 110 includes two co-located transceivers operating according to respective RATs, including a primary RAT transceiver 140 configured to operate in accordance with one RAT to predominantly communicate with the access terminal 120 and a secondary RAT transceiver 142 configured to operate in accordance with another RAT to predominantly interact with other RATs sharing the communication medium 132 such as the competing RAT system 202. As used herein, a “transceiver” may include a transmitter circuit, a receiver circuit, or a combination thereof, but need not provide both transmit and receive functionalities in all designs. For example, a low functionality receiver circuit may be employed in some designs to reduce costs when providing full communication is not necessary (e.g., a W-Fi chip or similar circuitry simply providing low-level sniffing). Further, as used herein, the term “co-located” (e.g., radios, access points, transceivers, etc.) may refer to one of various arrangements. For example, components that are in the same housing; components that are hosted by the same processor; components that are within a defined distance of one another; and/or components that are connected via an interface (e.g., an Ethernet switch) where the interface meets the latency requirements of any required inter-component communication (e.g., messaging).

The primary RAT transceiver 140 and the secondary RAT transceiver 142 may accordingly provide different functionalities and may be used for different purposes. Returning to the LTE and Wi-Fi example above, the primary RAT transceiver 140 may operate in accordance with LTE technology to provide communication with the access terminal 120 on the wireless link 130, while the secondary-RAT transceiver 142 may operate in accordance with Wi-Fi technology to monitor or control Wi-Fi signaling on the communication medium 132 that may interfere with or be interfered with by the LTE communications. The secondary RAT transceiver 142 may or may not serve as a full W-Fi access point providing communication services to an associated Basic Service Set (BSS). The communication device 122 of the access terminal 120 may, in some designs, include similar primary RAT transceiver and/or secondary RAT transceiver functionality, as shown in FIG. 1 by way of the primary RAT transceiver 150 and the secondary RAT transceiver 152, although such dual-transceiver functionality may not be required.

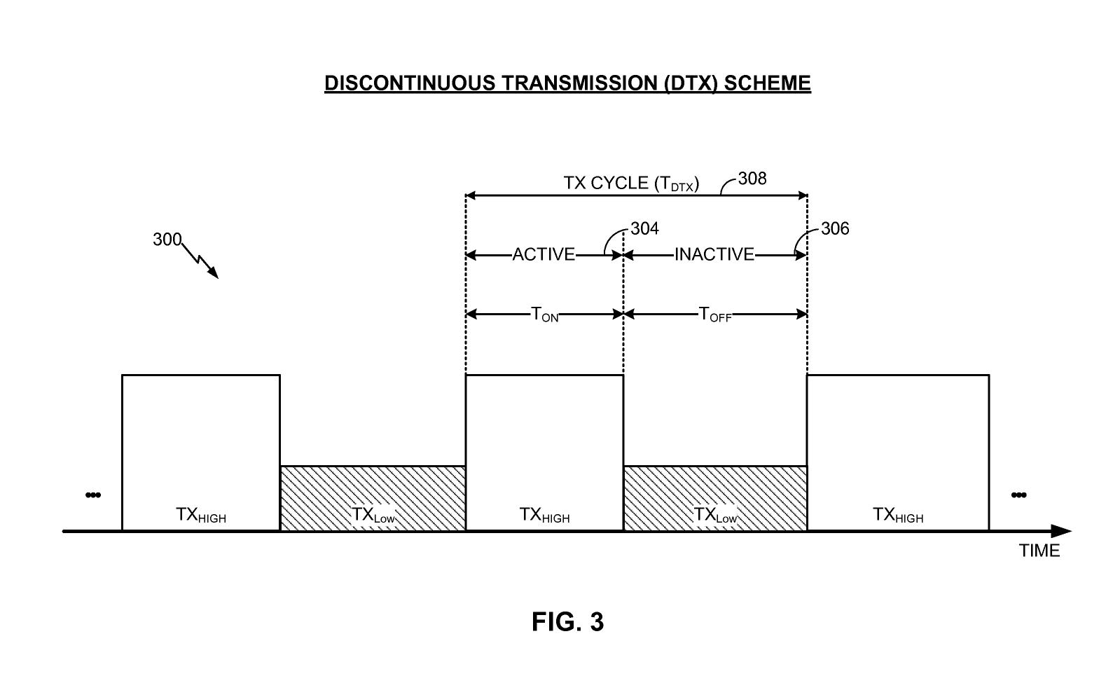

FIG. 3 illustrates certain aspects of an example Discontinuous Transmission (DTX) communication scheme that may be implemented by the primary RAT system 200 on the communication medium 132. The DTX communication scheme may be used to foster time-division-based co-existence with the competing RAT system 202. As shown, usage of the communication medium 132 for primary RAT communication may be divided into a series of active periods 304 and inactive periods 306 of communication. The relationship between the active periods 304 and the inactive periods 306 may be adapted in different ways to promote fairness between the primary RAT system 200 and the competing RAT system 202.

A given active period 304/inactive period 306 pair may constitute a transmission (TX) cycle (T_{DTX}) 308, which collectively form a communication pattern 300. During a period of time T_{ON} associated with each active period 304, primary RAT communication on the communication medium 132 may proceed at a normal, relatively high transmission power (TX_{HIGH}). During a period of time T_{OFF} associated with each inactive period 306, however, primary RAT communication on the communication medium 132 may be disabled or at least sufficiently reduced to a relatively low transmission power (TX_{LOW}) in order to yield the communication medium 132 to the competing RAT system 202. During this time, various network listening functions and associated measurements may be performed by the access point 110 and/or the access terminal 120, such as medium utilization measurements, medium utilization assessment sensing, and so on.

The DTX communication scheme may be characterized by a set of one or more DTX parameters. Each of the associated DTX parameters, including, for example, a period duration (e.g., the length of T_{DTX}), a duty cycle (e.g., T_{ON}/T_{DTX}) and the respective transmission powers during active periods 304 and inactive periods 306 (TX_{HIGH} and TX_{LOW}, respectively), may be adapted based on the current signaling conditions on the communication medium 132 to dynamically optimize the fairness of the DTX communication scheme.

With reference again to FIG. 1, the secondary RAT transceiver 142 may be configured to monitor the communication medium 132 during the time period T_{OFF} for secondary RAT signaling, such as signaling from the competing RAT system 202, which may interfere with or be interfered with by primary RAT signaling over the communication medium 132. A utilization metric may then be determined that is associated with utilization of the communication medium 132 by the secondary RAT signaling. Based on the utilization metric, one or more of the associated parameters discussed above may be set and the primary RAT transceiver 140 may be configured to cycle between active periods 304 of communication and inactive periods 306 of communication over the communication medium 132 in accordance therewith.

As an example, if the utilization metric is high (e.g., above a threshold), one or more of the parameters may be adjusted such that usage of the communication medium 132 by the primary RAT transceiver 140 is reduced (e.g., via a decrease in the duty cycle or transmission power). Conversely, if the utilization metric is low (e.g., below a threshold), one or more of the parameters may be adjusted such that usage of the communication medium 132 by the primary RAT transceiver 140 is increased (e.g., via an increase in the duty cycle or transmission power).

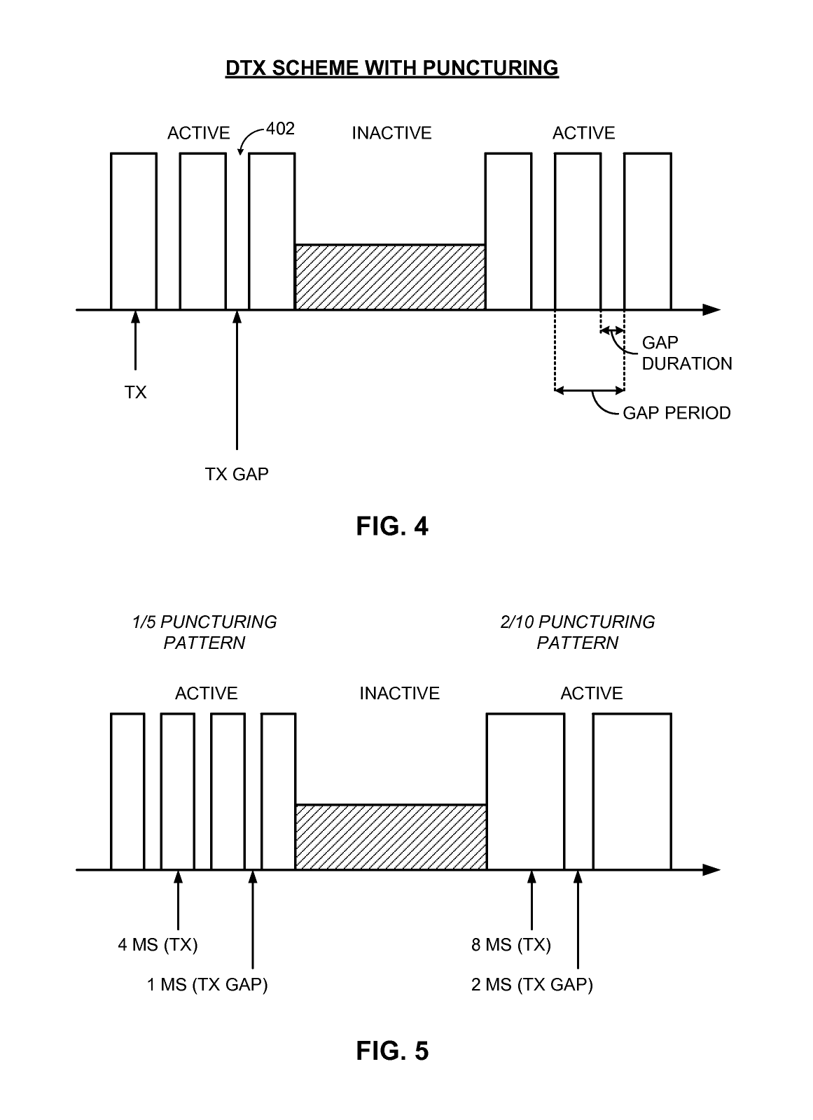

FIG. 4 illustrates additional aspects of a DTX communication scheme and shows what is referred to herein as puncturing. As in FIG. 3, during active periods 304 of communication, primary RAT transmission on the communication medium 132 is enabled. During inactive periods 306, primary RAT transmission on the communication medium 132 is substantially disabled to allow for competing RAT operations, to conduct measurements, and so on. Within a given active period 304, however, transmission may be punctured as shown to better accommodate certain operations of the competing RAT system 202. As used herein, “puncturing” refers to the transmission of some signals ordinarily associated with a given frame, subframe, or the like, and the omission of other signals ordinarily associated with that frame, subframe, or the like.

Puncturing may be used to introduce relatively frequent transmission (TX) gaps 402 during one or more of the active periods 304. The transmission gaps 402 may be useful for co-existence with latency-sensitive traffic of the competing RAT system 202, such as Voice over Internet Protocol (VoIP) traffic. The transmission gaps 402 may also be useful for helping to unblock certain channels of the competing RAT system 202 that may not be directly impacted but may be nevertheless restricted from operating due to primary RAT transmission over the communication medium 132.

For example, it has been found that certain Wi-Fi implementations may not fully distinguish between primary and secondary channel interference. Although the IEEE 802.11 protocol family of standards provides a Clear Channel Assessment (CCA) Energy Detection (ED) mechanism and corresponding CCA-ED threshold for assessing the state of a communication medium prior to attempting transmission and this mechanism defines at least one-way independence between primary and secondary channels, such that a busy secondary channel will not by itself impede primary channel operation, these Wi-Fi implementations have been found to follow a more simplistic, aggregate approach in which signaling energy detected above the CCA-ED threshold anywhere over an operating bandwidth leads to a busy indication for all channels including the primary channel. This may result in a Wi-Fi node unnecessarily backing off of control, management, and time-sensitive data packet transmissions on a primary channel even when interference is present only on a secondary channel, and may therefore adversely affect Wi-Fi connection setup, management/discovery frames such as Wi-Fi beacons, low-rate latency-sensitive traffic (e.g., VoIP), etc.

Since energy detection in Wi-Fi, for example, is persistent in that a CCA check is performed once every slot duration (e.g., 9 μs), a blocked Wi-Fi node will be able to seize the communication medium 132 in the first slot that falls inside one of the transmission gaps 402 after an interframe spacing (IFS) period. A transmission gap on the order of approximately 1-2 subframes (e.g., 1-2 ms), as an example, has been found to be sufficient to flush short packets such as beacon signals and low-rate latency-sensitive traffic (e.g., VoIP) from a Wi-Fi node's buffer. Introducing the transmission gaps 402 frequently (e.g., for a few milliseconds every tens of milliseconds) allows the competing RAT system 202 to periodically flush such packets without being blocked for a long time by primary RAT transmissions of the primary RAT system 200. In addition, frequent gaps may be used to help implementations using handshake control signaling (e.g., Request-to-Send (RTS)/Clear-to-Send (CTS) messages), which may implicitly use the transmission gaps 402 provided by puncturing.

Accordingly, the access point 110 may monitor signaling of the competing RAT system 202 (e.g., via the secondary RAT transceiver 142) on the communication medium 142 and puncture transmission in accordance with the primary RAT on one or more of the active periods 304 of the DTX communication pattern 300 based on the monitoring. As an example, the access point 110 may measure a signaling energy associated with the monitored signaling and puncture transmission in response to the measured signaling energy being above a backoff threshold (e.g., CCA-ED threshold) associated with the competing RAT system 202. As another example, the access point 110 may detect latency-sensitive traffic associated with the monitored signaling and puncture transmission in response to the detected latency-sensitive traffic.

FIG. 5 illustrates several example puncturing patterns that may be employed. In general, the puncturing patterns define the gap duration and gap periodicity of one or more subframes to be punctured. In one illustrated example, a “1/5” puncturing pattern is employed in which 1 ms transmission gaps are introduced for every 5 ms transmission period of the active period 304. In another illustrated example, a “2/10” puncturing pattern is employed in which 2 ms transmission gaps are introduced for every 10 ms transmission period of the active period 304. Other example puncturing patterns include, but are not limited to, a “1/10” puncturing pattern, a “2/20” puncturing pattern, a “4/40” puncturing pattern, and so on.

The puncturing pattern and corresponding gap duration and gap periodicity parameters may vary from application to application. For example, the gap duration and gap periodicity may be set based on a latency target for the competing RAT system 202 being affected (e.g., a 2 ms gap every 10 ms period). The latency target may be reflective of the need of the competing RAT system 202 to flush low-latency traffic, for example, without being blocked by primary RAT transmission. As another example, the gap duration and gap periodicity may be set based on a signaling energy (e.g., Received Signal Strength Indicator (RSSI)) of the competing RAT system 202 being affected. A more aggressive puncturing pattern may be used when the signaling energy of the competing RAT system 202 is relatively high to better accommodate nodes of the competing RAT system 202 that are likely to be more nearby. As another example, the gap duration and gap periodicity may be set based on a channel type, primary or secondary, of the detected channel operation of the competing RAT system 202 being affected. The access point 110 can discriminate between primary and secondary channel operation by detecting a beacon signal or the like (e.g., via the secondary RAT transceiver 142) and reading the content of the beacon signal, which may contain information identifying the channel as a primary or secondary channel. A more aggressive puncturing pattern may be used when the access point 110 detects that the competing RAT system 202 is operating on a primary channel as opposed to a secondary channel, when the access point 110 detects that the competing RAT system 202 is exchanging VoIP traffic, or when the access point 110 detects other prioritization conditions.

As is further illustrated in FIG. 5, the gap duration and gap periodicity may be set statically or may be set dynamically and vary across (or even within) different active periods 304, depending on current signaling conditions or other considerations. For example, the puncturing pattern may depend on the number of distinct access points of the competing RAT system 202 detected above an associated backoff threshold (e.g., a CCA-ED threshold for Wi-Fi). The access point 110 may detect the number of access points operating in accordance with the competing RAT system 202 and experiencing a signaling energy above the backoff threshold. Based on the number of such access points detected, the access point 110 may set the transmission gap duration and the transmission gap periodicity of the puncturing pattern. For example, the duty cycle of puncturing may be set higher when there are more Wi-Fi access points detected above the CCA-ED threshold. The access point 110 can identify individual access points by detecting a beacon signal or the like (e.g., via the secondary RAT transceiver 142) and reading the content of the beacon signal, which contains information identifying the access point transmitter. Similar techniques may be applied to various RATs.

Other system parameters may also be set or adjusted to harmonize with the puncturing pattern employed. For example, one or more cycling parameters of the corresponding DTX communication pattern 300 may be set based on the puncturing pattern. It may be helpful to extend the active period 304, for example, to compensate for lost transmission opportunities due to the puncturing.

Returning to FIG. 4, different puncturing mechanisms may be employed to effectuate the desired puncturing pattern. For example, in the simplest case, the access point 110 may refrain from transmitting during the scheduled transmission gaps 402. In other examples, however, the access point 110 may employ more advanced techniques, such as data channel (e.g., Physical Downlink Shared Channel (PDSCH)) muting or broadcast channel (e.g., Multicast-Broadcast Single-Frequency Network (MBSFN), Almost Blank Subframe (ABS), etc.) blanking, to more systematically mitigate potential service disruptions. It will accordingly be appreciated that puncturing and punctured subframes of the type described herein are not limited to completely blank subframes but may still include, for example, certain control signaling on some symbols of the subframe for use in maintaining system coordination and the like.

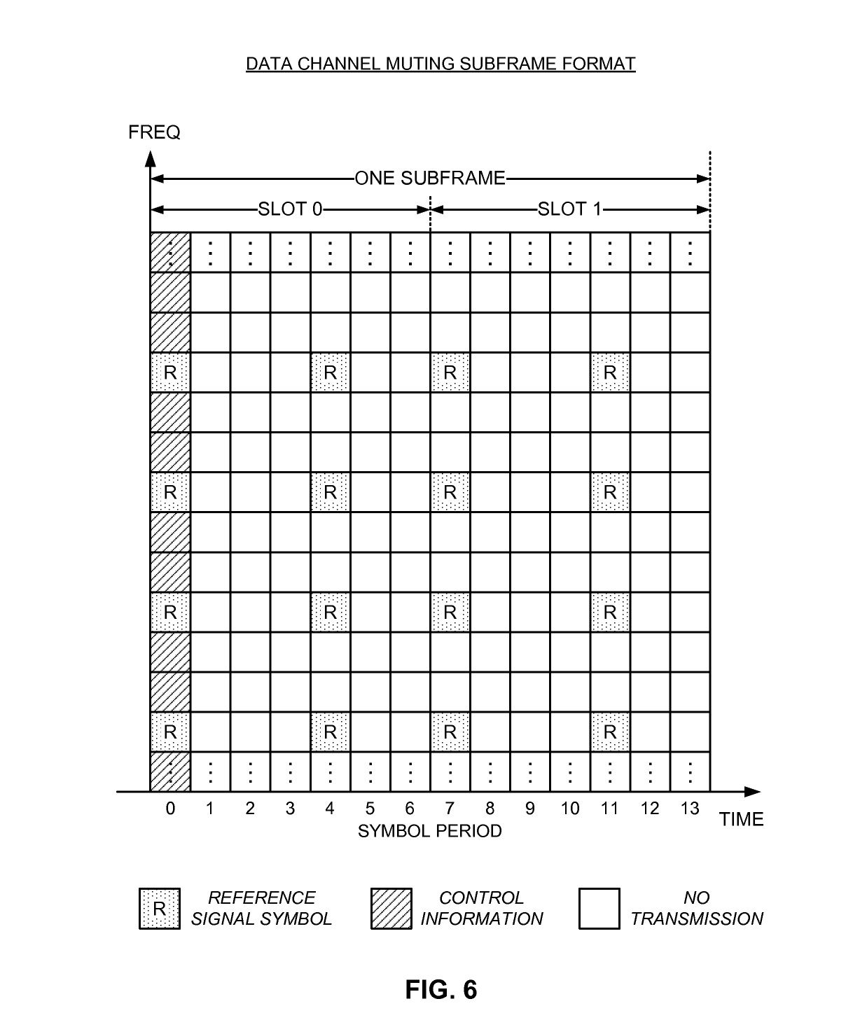

FIG. 6 is a resource map diagram illustrating an example data channel muting subframe format for use in subframe puncturing. In this example, the data channel is provided via PDSCH.

Ordinarily, PDSCH subframes include (i) a Cell-specific Reference Signal (CRS) in the first and fifth symbol periods of each slot of the subframe and control signaling in the first M periods of the subframe, where M≦1 depending on the number of antenna ports, and (ii) data in the remaining symbol periods of the subframe. A muted PDSCH subframe of the type illustrated in FIG. 6 includes (i) the CRS signal and the control information in the first M symbol periods of the subframe but (ii) no data transmissions in the remaining symbol periods of the subframe. The PDSCH muting configuration may be user-specific and signaled via a higher-layer. The intra-subframe location of muted resource elements can be indicated by a corresponding bitmap, for example, where all resource elements set to 1 are muted (zero power assumed at the access terminal 120).

In more detail and with reference to FIG. 6, a reference signal such as CRS may be sent in symbol period 0 (e.g., on different sets of subcarriers from different antennas). Control information such as a Physical Control Format Indicator Channel (PCFICH) may also be sent in symbol period 0 of the subframe, as well as a Physical Downlink Control Channel (PDCCH) and Physical Hybrid-ARQ Indicator Channel (PHICH), which may be sent in symbol periods 0 to M−1, where M=1 for the design shown in FIG. 6 but in general M≦3. No data transmissions are sent in the remaining symbol periods M to 13.

By designating one or more subframes for data channel operation in accordance with the desired puncturing pattern, the access point 110 may then refrain from scheduling data during one or more corresponding symbol periods to free the communication medium 132 for operations of the competing RAT system 202. As shown in FIG. 6, a muted subframe may not be completely blank because CRS or other control signaling may still be sent on some symbols of the subframe. The other symbols will provide sufficient opportunities for the competing RAT system 202 to seize the communication medium 132, however, resulting in a transmission that will be triggered to proceed to completion and thereby produce the intended effect of unblocking one or more associated channels.

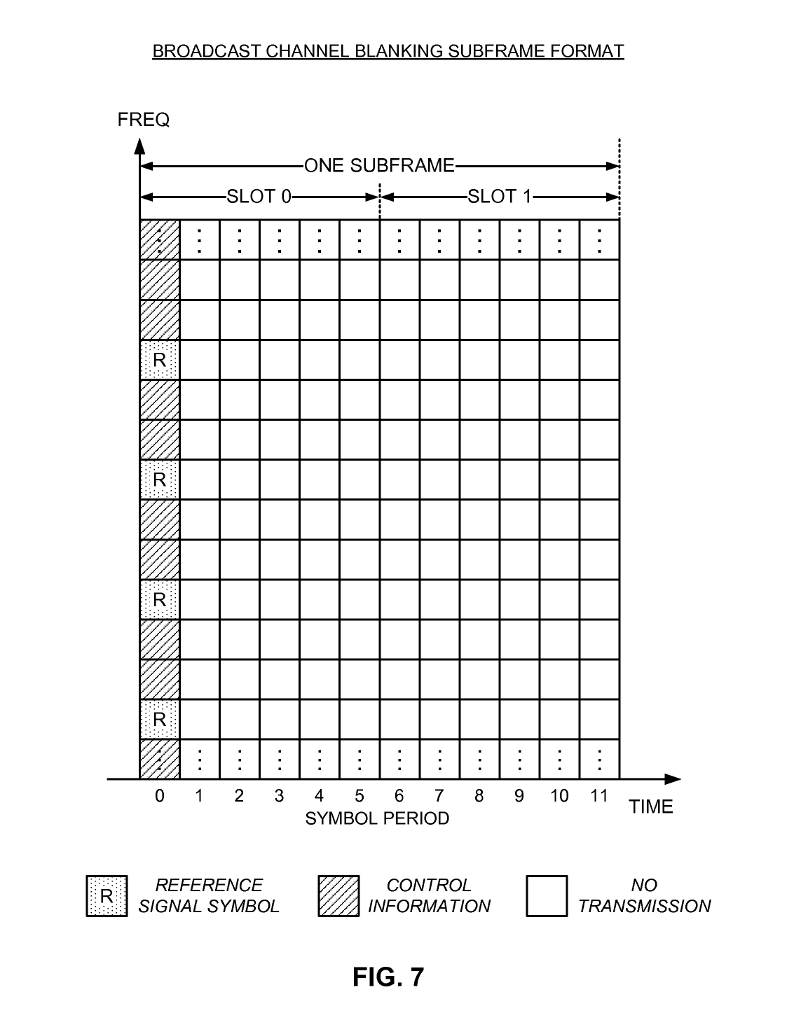

FIG. 7 is a resource map diagram illustrating an example broadcast channel blanking subframe format for use in subframe puncturing. In this example, the broadcast channel is provided via MBSFN.

Ordinarily, MBSFN subframes include (i) a CRS signal and control information in the first M symbol periods of the subframe, where M is typically 1 or 2 depending on the number of antenna ports, and (ii) broadcast data in the remaining symbol periods of the subframe. A blanked MBSFN subframe of the type illustrated in FIG. 7 includes (i) the CRS signal and the control information in the first M symbol periods of the subframe but (ii) no transmissions in the remaining symbol periods of the subframe.

In more detail and with reference to FIG. 7, a reference signal such as CRS may be sent in symbol period 0 (e.g., on different sets of subcarriers from different antennas). Control information such as PCFICH may also be sent in symbol period 0 of the subframe, as well as PDCCH and PHICH, which may be sent in symbol periods 0 to M−1, where M=1 for the design shown in FIG. 7 but in general M≦2 for MBSFN subframes. No data or control transmissions are sent in the remaining symbol periods M to 11.

By designating one or more subframes for broadcast channel operation in accordance with the desired puncturing pattern, the access point 110 may reserve one or more corresponding symbol periods for a multi-cell transmission and then refrain from transmitting during the one or more corresponding symbol periods to free the communication medium 132 for operations of the competing RAT system 202. As shown in FIG. 7, a blanked subframe may not be completely blank because CRS or other control signaling may still be sent on some symbols of the subframe. The other symbols will provide sufficient opportunities for the competing RAT system 202 to seize the communication medium 132, however, resulting in a transmission that will be triggered to proceed to completion and thereby produce the intended effect of unblocking one or more associated channels.

For a more aggressive puncturing pattern, the number of subframes designated for broadcast channel operation may be set to the maximum number available under a corresponding communication protocol. The maximum number of subframes for broadcast channel operation in LTE MBSFN, for example, is typically 3 subframes out of every 5 subframes (or 3 ms every 5 ms). This is due to the restriction that subframes 0, 4, 5, and 9 in the LTE Frequency Division Duplex (FDD) variant and subframes 0, 1, 5, and 6 in the LTE Time Division Duplex (TDD) variant cannot be designated as MBSFN subframes.

It will appreciated that other puncturing mechanisms may be employed as well, including, for example, Almost Blank Subframe (ABS) muting, in which the access point 110 may transmit certain control channels and cell-specific reference signals while omitting user data that would otherwise be transmitted during corresponding symbol periods of a given subframe. The transmitted control channels and cell-specific reference signals may also be sent with reduced power.

Latency-sensitive traffic may be detected in different ways. In some instances, latency-sensitive traffic may be detected directly by packet decoding, while in other instances, such as where packets are encrypted, different indirect approaches based on packet statistics may be employed. Examples of latency-sensitive traffic detection are described in more detail below.

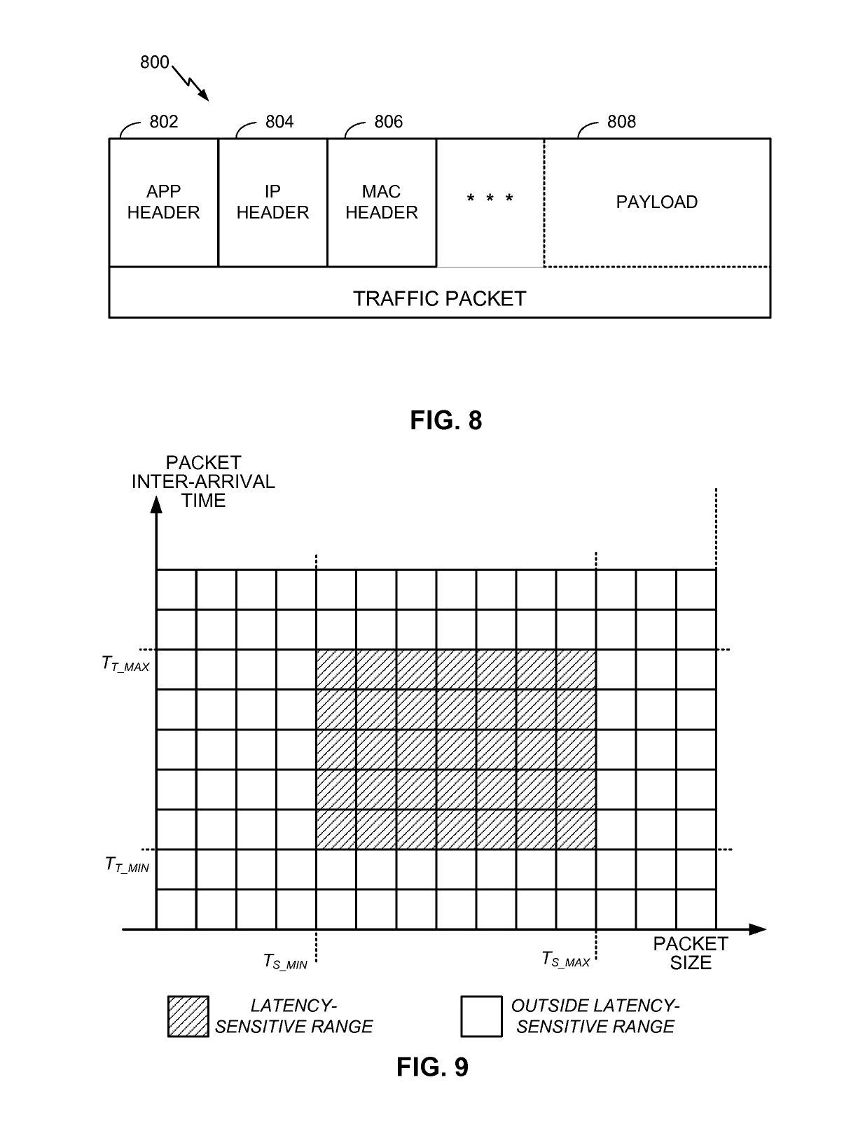

FIG. 8 illustrates an example traffic packet showing select header information for identifying low-latency traffic. In this example, the traffic packet 800 carries headers for different protocol layers, including an application layer header 802, an Internet Protocol (IP) layer header 804, and a Medium Access Control (MAC) layer header 806, among other information (illustrated generically as payload 808). Other protocol layer headers may also be included in a given packet (e.g., a transport layer header, etc.).

When accessible, one or more of the header regions of the packet 800 may be decoded and read (e.g., using the secondary RAT transceiver 142) for information indicative of latency-sensitive traffic. For example, the application layer header 802 may indicate for a given flow the use of an application-layer latency-sensitive traffic protocol such as a Real Time Protocol (RTP), a G.711 compression algorithm, a G.729 compression algorithm, etc. As another example, the IP layer header 804 may indicate for a given flow the use of an IP-layer latency-sensitive traffic protocol such as a real-time priority Type of Service (ToS), etc. As another example, the MAC layer header 806 may indicate for a given flow the use of a MAC-layer latency-sensitive traffic protocol such as a voice- or video-priority Quality of Service (QoS), etc.

In some systems or scenarios, however, such header information may not be accessible. For example, one or more of the header regions of the packet 800 may be encrypted and therefore indecipherable to the access point 110 performing packet sniffing. In such instances, other, indirect approaches based on packet statistics may be employed.

FIG. 9 is a statistical distribution illustrating a mapping between different packet characteristics for a given flow and their correspondence to latency-sensitive traffic. In this example, the characteristics include a packet length characteristic “size” and a packet spacing characteristic “inter-arrival time.” For one or more detected traffic flows, the access point 110 may track such characteristics over a plurality of associated packets. The corresponding statistics may be compared to the statistical distribution as hypothesis testing for latency-sensitive traffic.

As shown in more detail in FIG. 9, corresponding thresholds for each characteristic may be established, such as the illustrated minimum and maximum packet size thresholds {T_{S}_{_{—}}_{MIN}, T_{S}_{_{—}}_{Max}} and the illustrated minimum and maximum packet inter-arrival time thresholds {T_{T}_{_{—}}_{MIN}, T_{T}_{_{—}}_{Max}}. Statistical observations falling within the latency-sensitive traffic range defined by these thresholds may be taken as an indication that the associated traffic flow is a latency-sensitive traffic flow. Statistical observations falling outside of the latency-sensitive traffic range defined by these thresholds may be taken as an indication that the associated traffic flow is not a latency-sensitive traffic flow.

The thresholds may be based on nominal values associated with certain latency-sensitive traffic and a given or empirically-derived margin of error. For example, VoIP payloads may be on the order of 200 bytes in size and arrive with a mean inter-arrival time of approximately 20 ms. These values are largely standardized by the corresponding codecs used for processing VoIP, but other values may be used by other systems.

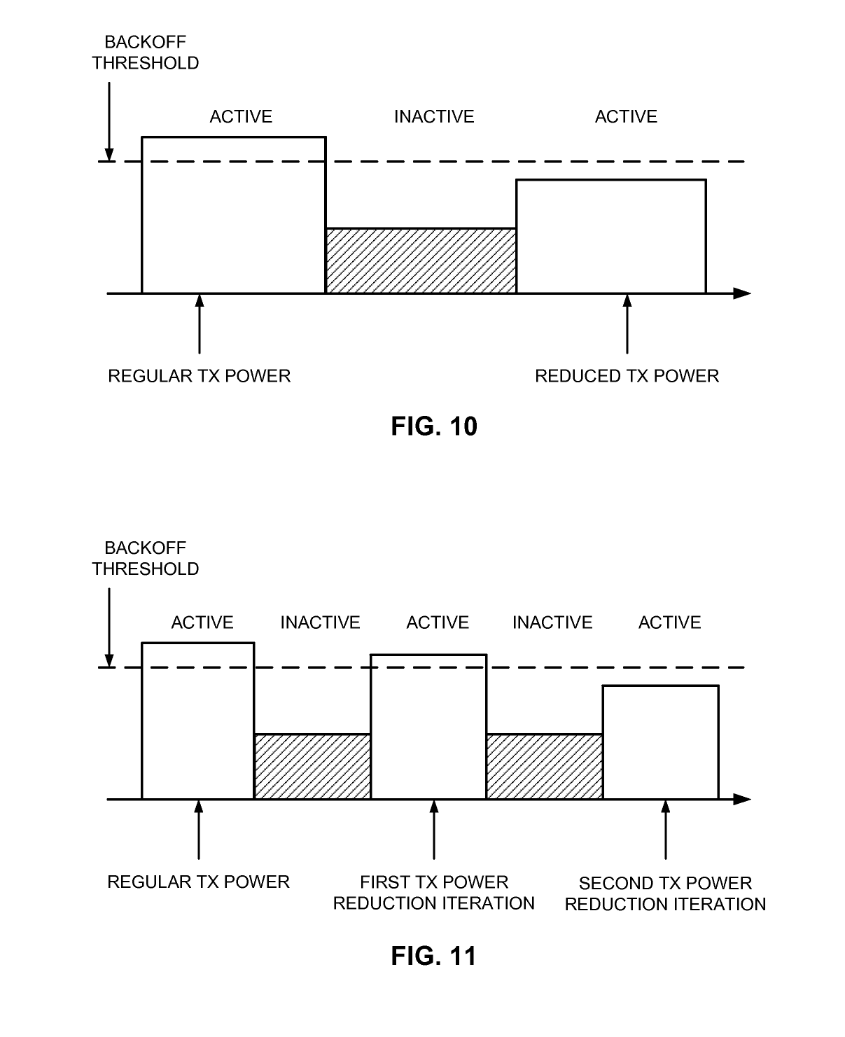

FIG. 10 illustrates an example of transmission power modification in the context of a DTX communication scheme. As in FIG. 3, during active periods 304 of communication, primary RAT transmission on the communication medium 132 is enabled. During inactive periods 306, primary RAT transmission on the communication medium 132 is substantially disabled to allow for competing RAT operations, to conduct measurements, and so on. Across active periods 306, however, the transmission power level for primary RAT transmissions may be reduced to better accommodate operation of the competing RAT system 202.

Transmission power reduction may help unblock transmission within the competing RAT system 202 if primary RAT signaling energy is being perceived by the competing RAT system 202 at above a backoff threshold (e.g., a CCA-ED threshold) defined by the competing RAT system 202 for accessing the communication medium 132. In the illustrated example, the access point 110 may initially transmit a first signal at a first (regular) transmission power level while monitoring signaling of the competing RAT system 202 (e.g., via the secondary RAT transceiver 142). Based on inferences derived from various signal timing characteristics, the access point 110 may reduce the first transmission power level to a second transmission power level and subsequently transmit a second signal at the second (reduced) transmission power level.

It will therefore be appreciated that the present disclosure provides inter-RAT-based power control of an access point itself that may not only supplement access terminal power loops, but may also utilize signal timing characteristics instead of direct signal energy measurements, which may not always be available or practical.

The degree to which the transmission power is reduced may be determined in different ways. If available, the appropriate transmission power level may be inferred directly from signal energy measurements or estimates as part of a power control feedback loop. In other instances, however, the appropriate transmission power level may be inferred indirectly from signal timing (actively or passively) observed for the affected RAT(s). Further, the appropriate transmission power level may be calculated from path loss (PL) estimates and/or other signaling condition information.

FIG. 11 illustrates an example transmission power reduction scheme. In this example, the transmission power is reduced iteratively until signaling energy is below the backoff threshold defined by the competing RAT system 202. For example, as described in more detail below, the monitored signal timing characteristics may be indicative of a timing delay associated with (i) a beacon inter-arrival periodicity or (ii) a probe request and probe response pair. The access point 110 may iteratively repeat monitoring the timing delay and reducing the transmission power level until the timing delay ceases. By way of example, a first transmission power reduction is shown that results in the signaling energy remaining slightly above the backoff threshold, followed by a second transmission power reduction in which the signaling energy is brought below the backoff threshold.

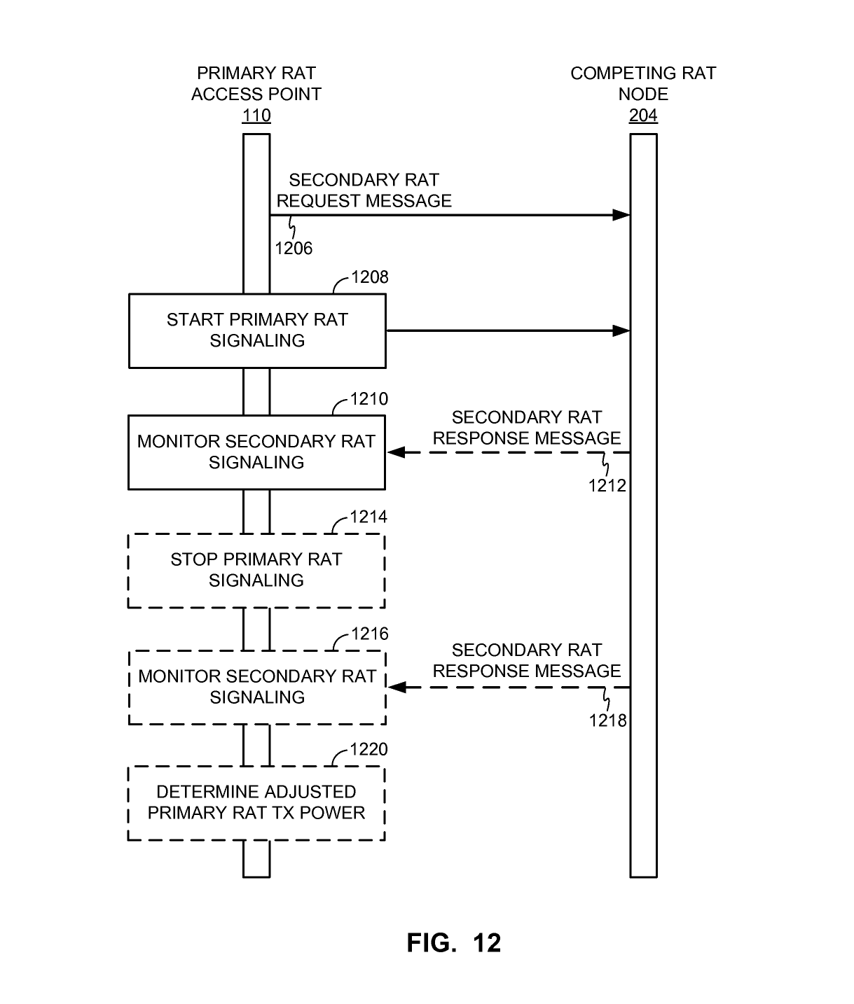

FIG. 12 is a signaling flow diagram illustrating another example transmission power reduction scheme. By way of example, the signaling is shown as between the access point 110 (having the co-located primary RAT transceiver 140 and secondary RAT transceiver 142) of the primary RAT system 200 and one of the competing RAT nodes 204 of the competing RAT system 202.

In this example, the access point 110 performs active signal probing of (and induced interference to) the competing RAT node 204 in order to gauge the perceived signaling energy at the competing RAT node 204. More specifically, the access point 110 sends a secondary RAT request message 1206 (e.g., a probe request message) to the competing RAT node 204, begins primary RAT signaling 1208 at its currently set transmission power level, and monitors secondary RAT signaling (block 1210). The monitoring may be performed by the secondary RAT transceiver 142 and may employ various advanced receiver interference-cancellation techniques to look through the concurrent primary RAT signaling.

If a secondary RAT response message 1212 (e.g., a probe response message) is received while the access point 110 is transmitting the primary RAT signaling at its currently set transmission power level, it may be inferred that the currently set transmission power is not being perceived at the competing RAT node 204 at above the backoff threshold. No adjustments to the primary RAT transmission power level are therefore necessary, although, in some scenarios (e.g., if the primary RAT transmission power had been previously lowered from a desired value), the access point 110 may choose to increase the primary RAT transmission power.

On the other hand, if no secondary RAT response message is received while the access point 110 is transmitting the primary RAT signaling 1208 at its currently set transmission power, it is possible that the currently set transmission power is being perceived at the competing RAT node 204 at above the backoff threshold and preventing the competing RAT node 204 from sending the appropriate response. As a further check (e.g., to distinguish between this blocking scenario and alternatives such as the access point 110 being in fact too far away to reach the competing RAT node 204 with the secondary RAT request message 1206), the access point 110 may stop primary RAT signaling (optional block 1214) and again monitor secondary RAT signaling (optional block 1216). If a secondary RAT response message 1218 (e.g., a probe response message) is received after the access point 110 has stopped transmitting the primary RAT signaling, it may be inferred that the currently set transmission power is being perceived at the competing RAT node 204 at above the backoff threshold. An adjustment to the primary RAT transmission power may then be determined (optional block 1220). In accordance with the discussion above, the adjustment may be performed iteratively as necessary.

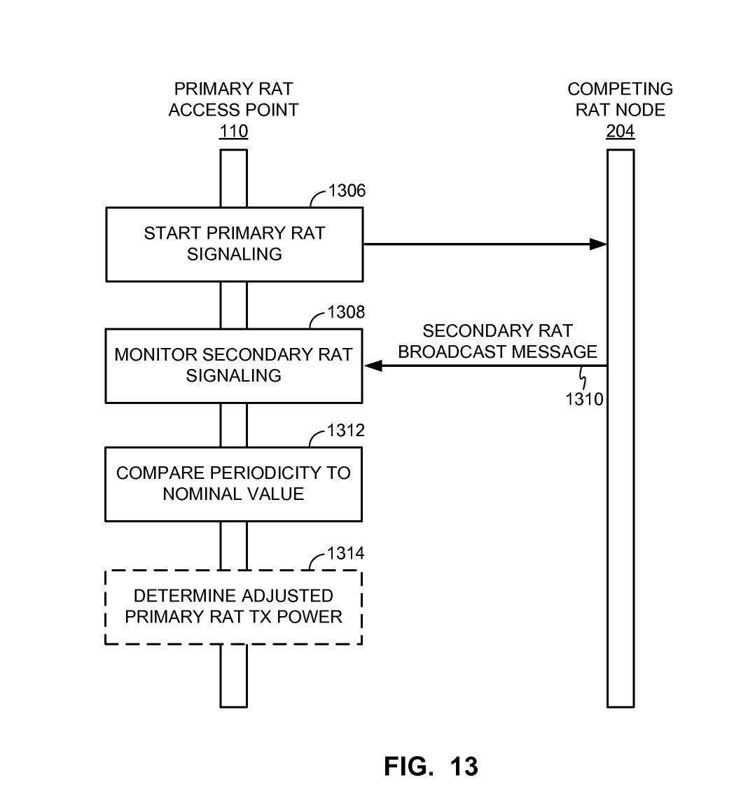

FIG. 13 is a signaling flow diagram illustrating another example transmission power reduction scheme. By way of example, the signaling is again shown as between the access point 110 (having the co-located primary RAT transceiver 140 and secondary RAT transceiver 142) of the primary RAT system 200 and one of the competing RAT nodes 204 of the competing RAT system 202.

In this example, the access point 110 performs passive signal monitoring of (and induced interference to) the competing RAT node 204 in order to gauge the perceived signaling energy at the competing RAT node 204. More specifically, the access point 110 begins primary RAT signaling 1306 at its currently set transmission power level and monitors secondary RAT signaling (block 1308) for occurrences of a given broadcast message 1310 (e.g., a beacon signal). The monitoring may be performed by the secondary RAT transceiver 142 and may employ various advanced receiver interference-cancellation techniques to look through the concurrent primary RAT signaling.

The observed periodicity of the secondary RAT broadcast message 1310 may be compared to a nominal or expected value under non-blocking conditions (block 1312). For example, the nominal or expected periodicity of a Wi-Fi beacon may generally assumed to be on the order of 100 ms. The nominal or expected periodicity of a Wi-Fi beacon may also be read by decoding one of the Wi-Fi beacons itself or otherwise calculated based on observations under non-blocking conditions. If the comparison reveals a longer than expected periodicity during the primary RAT signaling at its currently set transmission power level, it may be inferred that the currently set transmission power is being perceived at the competing RAT node 204 at above the backoff threshold. An adjustment to the primary RAT transmission power may then be determined (optional block 1314). In accordance with the discussion above, the adjustment may be performed iteratively as necessary.

In general, the access point 110 may estimate the perceived signaling energy of its primary RAT transmissions on the competing RAT system 202 in a reciprocal manner based on secondary RAT signaling measurements taken at the access point 110 itself and/or certain operating channel condition assumptions. For example, assuming that the access point 110 and competing RAT system 202 transmission powers are substantially similar, the access point 110 may substantially equate the two and take them as effectively reciprocal pairs. That is, the signaling energy perceived by the access point 110 may be assumed to be equivalent to the signaling energy perceived by one of the competing RAT nodes 204 of the competing RAT system 202.

In other instances, however, the access point 110 may use secondary RAT signaling to calculate a path loss over the communication medium 132. Based on the path loss, the access point 110 can more accurately compute the signaling energy perceived by one of the competing RAT nodes 204 of the competing RAT system 202.

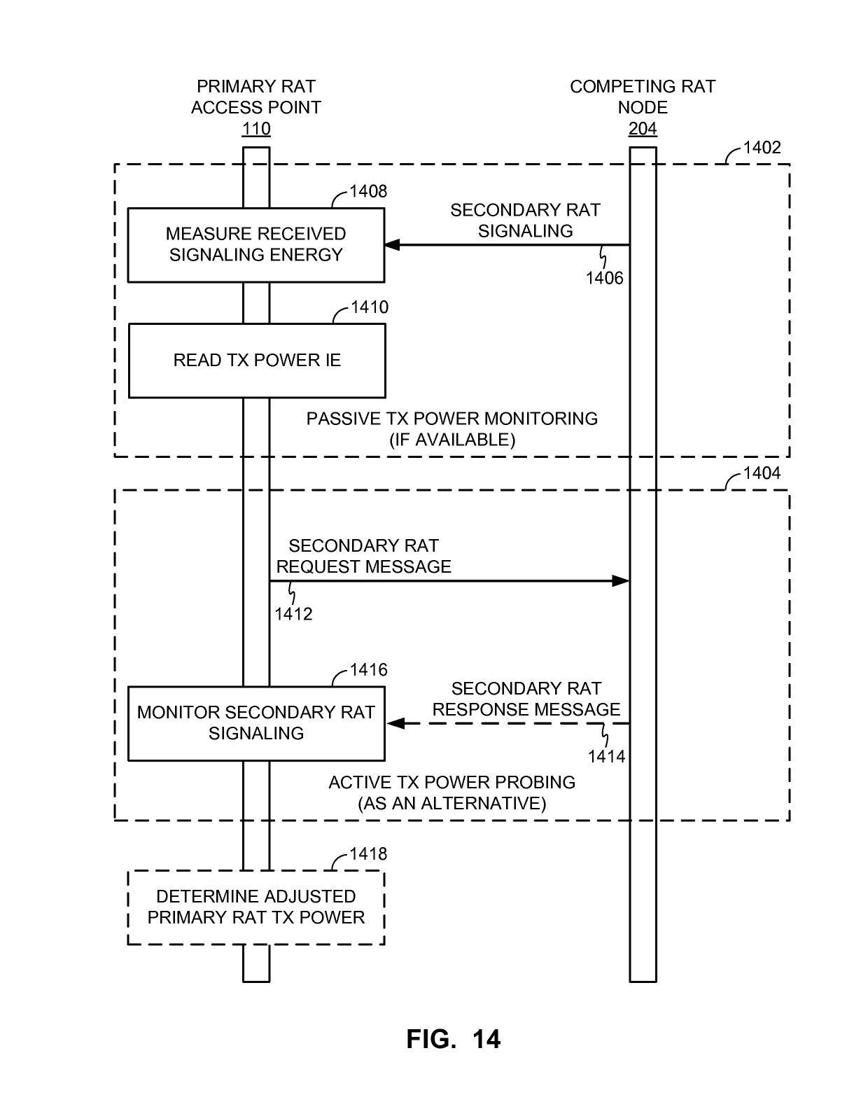

FIG. 14 is a signaling flow diagram illustrating another example transmission power reduction scheme. By way of example, the signaling is again shown as between the access point 110 (having the co-located primary RAT transceiver 140 and secondary RAT transceiver 142) of the primary RAT system 200 and one of the competing RAT nodes 204 of the competing RAT system 202.

In this example, the access point 110 may calculate a path loss over the communication medium 132 via passive transmission power monitoring (block 1402) of signaling sent by the competing RAT system 202, if available, or via active transmission power probing (block 1404) of its signaling.

Taking each approach in turn, in some situations, the path loss may be calculated from secondary RAT signaling measurements (e.g., RSSI) and their estimated transmission power, which may be directly or indirectly determined in various ways. More specifically, the access point 110 may receive secondary RAT signaling 1406, measure its received signaling energy (block 1408), and read some form of a transmission power Information Element (IE) therefrom (block 1410) to estimate its transmission power. For example, in some Wi-Fi implementations (e.g., IEEE 802.11h), a Wi-Fi access point may advertise a Transmit Power Control (TPC) Report IE in its beacon and/or probe response frames. The TPC Report IE or its equivalent contains the actual transmission power of the frame and a link margin. The access point 110 may accordingly decode and read such information from the secondary RAT signaling directly (e.g., via the secondary RAT transceiver 142). As another example, in some Wi-Fi implementations, a Wi-Fi access point may advertise country and/or local power constraint IEs in its beacon and/or probe response frames, which indicate the maximum transmission power at which the access point may be transmitting. The maximum transmission power may be taken as a conservative estimate of the actual transmission power. In either case, the path loss may be derived from the difference in received and transmitted signaling energies.

In other situations, such as when no direct transmission power indications or constraints are available, the access point 110 may actively probe the competing RAT node 204 at different signal strengths to assess the minimum transmission power required for successful transmission over the communication medium 132 between the two entities. More specifically, the access point 110 may transmit a series of secondary RAT request messages 1412 (e.g., probe request messages) at decreasing transmission power levels and monitor for secondary RAT response messages 1414 (e.g., probe response messages) to assess decoding success or failure of the secondary RAT request messages 1412 (block 1416). From this, the access point 110 may then determine a minimum transmission power for successful decoding of the secondary RAT request messages 1412. Based on the minimum transmission power and, for example, certain associated transmission power decoding requirements (e.g., a minimum Signal-to-Noise Ratio (SNR)), the access point 110 may determine received and transmitted signaling energies and thereby an estimate for the path loss.

An adjustment to the primary RAT transmission power may then be determined (optional block 1418) based on the path loss and the backoff threshold (e.g., a CCA-ED threshold) defined by the competing RAT system 202 for accessing the communication medium 132.

Returning again to FIG. 3, in some scenarios, it may be advantageous to use one of a set of predetermined or “fixed” DTX parameters rather than dynamically configuring the parameters to adapt to changing medium-utilization conditions.

For example, if the potential for inter-RAT interference is relatively high (e.g., the competing RAT nodes 204 of the competing RAT system 202 are close by, several in number, or overlapping on a primary channel), appropriate DTX parameters may be assumed to protect latency-sensitive or other operations that may not be accurately or timely reflected in the medium utilization calculations. Relatively long inactive periods 306 (e.g., on the order of hundreds of msec) may introduce latencies that are detrimental to some applications, including high QoS real-time or near real-time communications such as VoIP. To protect latency sensitive applications in scenarios where specific detection of such applications is not feasible or not practical, a tighter DTX cycle (i.e., shorter active/inactive period durations) may be employed and DTX parameter adaptation suspended.

Conversely, if the potential for substantial inter-RAT interference is relatively low or interference of a particular type is expected (e.g., one or more of the competing RAT nodes 204 of the competing RAT system 202 overlapping only on a secondary channel which does not support latency-sensitive traffic), appropriate DTX parameters for this scenario may be selected.

Examples of fixed-parameter triggers include, but are not limited to, one or more of the competing RAT nodes 204 of the competing RAT system 202 being detected above an (e.g., beacon) RSSI threshold (either primary or secondary operation), one or more of the competing RAT nodes 204 of the competing RAT system 202 being detected as operating on a primary channel (regardless of their RSSI), a threshold number of the competing RAT nodes 204 of the competing RAT system 202 being detected (regardless of their RSSI), and so on.

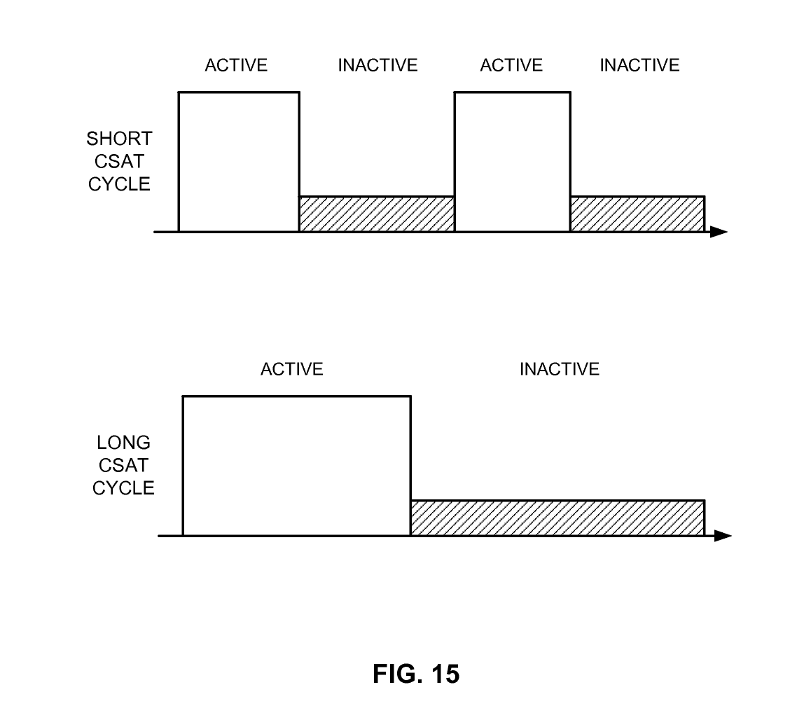

FIG. 15 illustrates an example of two fixed DTX communication schemes that may be employed upon detection of certain priority triggers. As in FIG. 3, during active periods 304 of communication, primary RAT transmission on the communication medium 132 is enabled. During inactive periods 306, primary RAT transmission on the communication medium 132 is substantially disabled to allow for competing RAT operations, to conduct measurements, and so on.

As is further illustrated in FIG. 15, in some situations, a short DTX cycle having fixed and relatively short active/inactive period durations may be employed, whereas in other situations, a long DTX cycle having fixed and relatively long active/inactive period durations may be employed. A short DTX cycle may be better suited to accommodating latency-sensitive traffic than a long DTX cycle, and a long DTX cycle may be better suited to accommodating non-latency-sensitive traffic.

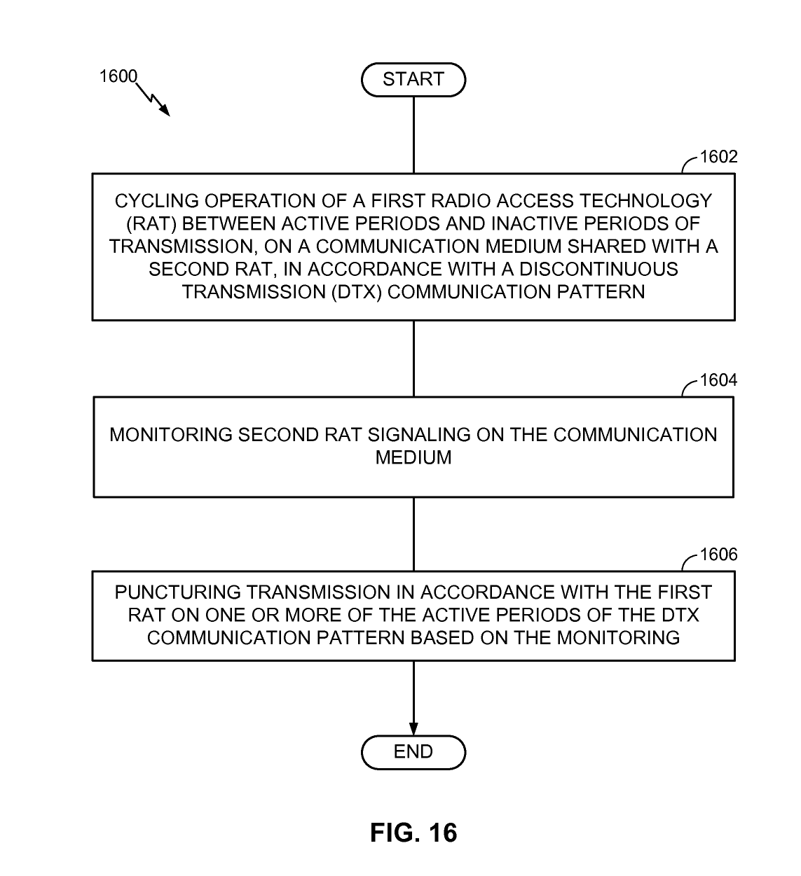

FIG. 16 is a flow diagram illustrating an example method of communication in accordance with the techniques described above. The method 1600 may be performed, for example, by an access point (e.g., the access point 110 illustrated in FIG. 1) operating on a shared communication medium. As an example, the communication medium may include one or more time, frequency, or space resources on an unlicensed radio frequency band shared between LTE technology and Wi-Fi technology devices.

As shown, the access point may cycle operation of a first RAT between active periods and inactive periods of transmission, on a communication medium shared with a second RAT, in accordance with a DTX communication pattern (block 1602). The cycling may be performed, for example, by a transceiver such as the primary RAT transceiver 140 or the like. The access point may also monitor second RAT signaling on the communication medium (block 1604). The monitoring may be performed, for example, by another transceiver such as the secondary RAT transceiver 142 or the like. The access point may then puncture transmission in accordance with the first RAT on one or more of the active periods of the DTX communication pattern based on the monitoring (block 1606). The puncturing may be performed, for example, by a processor and memory such as the processing system 116 and memory component 118 or the like.

As discussed in more detail above, the puncturing (block 1606) may include puncturing in accordance with a puncturing pattern that defines a transmission gap duration and a transmission gap periodicity. The access point may set the transmission gap duration and the transmission gap periodicity based on at least one of: a latency target for the second RAT; a signaling energy of the monitored second RAT signaling; a channel type, primary or secondary, of the monitored second RAT signaling; or a combination thereof. The access point may also detect, based on the monitored second RAT signaling, a number of second RAT access points having a signaling energy above a backoff threshold associated with the second RAT, and set the transmission gap duration and the transmission gap periodicity based on the number of second RAT access points detected. The access point may also set one or more cycling parameters of the DTX communication pattern based on the puncturing pattern.

As also discussed in more detail above, the puncturing (block 1606) may include, for example, designating one or more subframes for data channel operation with respect to one or more corresponding symbol periods and refraining from scheduling data during the one or more corresponding symbol periods. In addition or as an alternative, the puncturing (block 1606) may include, for example, designating one or more subframes for broadcast channel operation to reserve one or more corresponding symbol periods for a multi-cell transmission and refraining from transmitting during the one or more corresponding symbol periods.

As also discussed in more detail above, the monitoring (block 1604) may include measuring a signaling energy associated with the second RAT signaling and the puncturing (block 1606) may include puncturing in response to the measured signaling energy being above a backoff threshold associated with the second RAT. In addition or as an alternative, the monitoring (block 1604) may include detecting latency-sensitive traffic associated with the second RAT signaling and the puncturing (block 1606) may include puncturing in response to the detected latency-sensitive traffic.

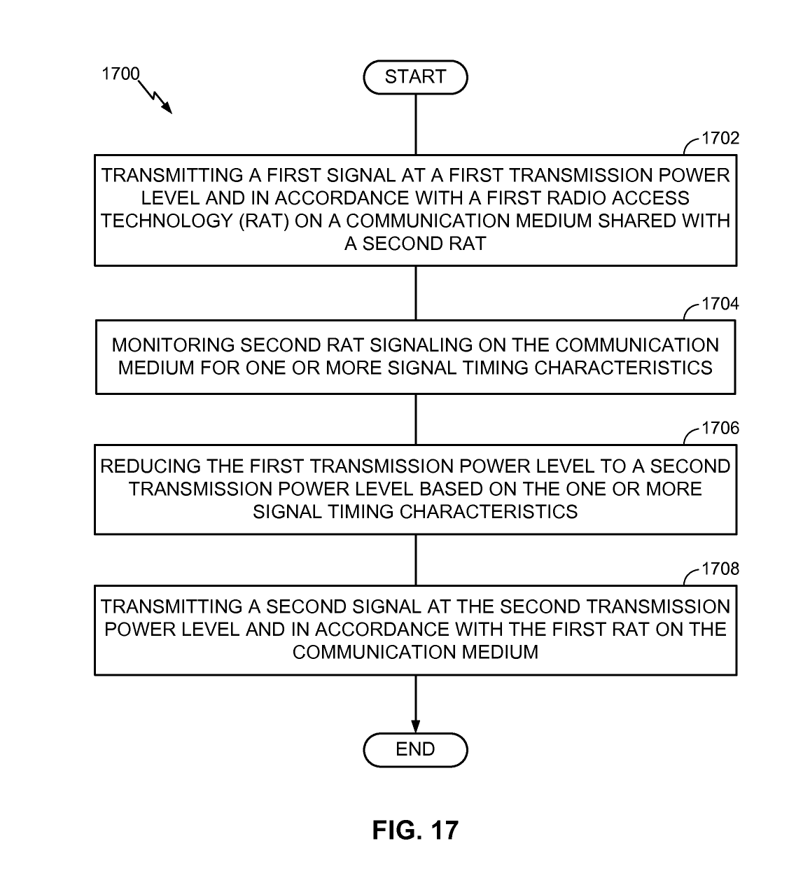

FIG. 17 is a flow diagram illustrating an example method of communication in accordance with the techniques described above. The method 1700 may be performed, for example, by an access point (e.g., the access point 110 illustrated in FIG. 1) operating on a shared communication medium. As an example, the communication medium may include one or more time, frequency, or space resources on an unlicensed radio frequency band shared between LTE technology and Wi-Fi technology devices.

As shown, the access point may transmit a first signal at a first transmission power level and in accordance with a first RAT on a communication medium shared with a second RAT (block 1702). The transmitting may be performed, for example, by a transceiver such as the primary RAT transceiver 140 or the like. The access point may also monitor second RAT signaling on the communication medium for one or more signal timing characteristics (block 1704). The monitoring may be performed, for example, by another transceiver such as the secondary RAT transceiver 142 or the like. The access point may then reduce the first transmission power level to a second transmission power level based on the one or more signal timing characteristics (block 1706). The reducing may be performed, for example, by a processor and memory such as the processing system 116 and memory component 118 or the like. The access point may then transmit a second signal at the second transmission power level and in accordance with the first RAT on the communication medium (block 1708). The transmitting may be performed, for example, by a transceiver such as the primary RAT transceiver 140 or the like.

As discussed in more detail above, the one or more signal timing characteristics being indicative of a timing delay associated with (i) a beacon inter-arrival periodicity or (ii) a probe request and probe response pair. The access point may also iteratively repeat the monitoring and the reducing until the timing delay ceases.

As also discussed in more detail above, the access point may also calculate a path loss associated with the second RAT signaling and compute the second transmission power level based on the path loss and a backoff threshold defined by the second RAT for accessing the communication medium. The backoff threshold may correspond, for example, to a CCA-ED threshold. As an example, the calculating may include measuring a received signaling energy of the second RAT signaling; estimating a transmission power associated with the second RAT signaling; and calculating the path loss based on the received signaling energy and the associated transmission power. The estimating may include reading from the second RAT signaling (i) a TPC Report IE or (ii) a country or local power constraint IE. As another example, the calculating may include transmitting a series of probe request messages in accordance with the second RAT at decreasing transmission power levels; monitoring probe response messages to assess decoding success or failure of the probe request messages; determining a minimum transmission power for successful decoding of the probe request messages based on the monitoring; and determining the path loss based on the minimum transmission power and an associated transmission power requirement for successful decoding.

As also discussed in more detail above, the access point may also cycle operation of the first RAT between active periods and inactive periods of transmission on the communication medium in accordance with a DTX communication pattern, with the transmitting (block 1708) of the second signal at the second transmission power level and in accordance with the first RAT aligning with one or more of the active periods of the DTX communication pattern.

For convenience, the access point 110 and the access terminal 120 are shown in FIG. 1 as including various components that may be configured according to the various examples described herein. It will be appreciated, however, that the illustrated blocks may be implemented in various ways. In some implementations, the components of FIG. 1 may be implemented in one or more circuits such as, for example, one or more processors and/or one or more ASICs (which may include one or more processors). Here, each circuit may use and/or incorporate at least one memory component for storing information or executable code used by the circuit to provide this functionality.

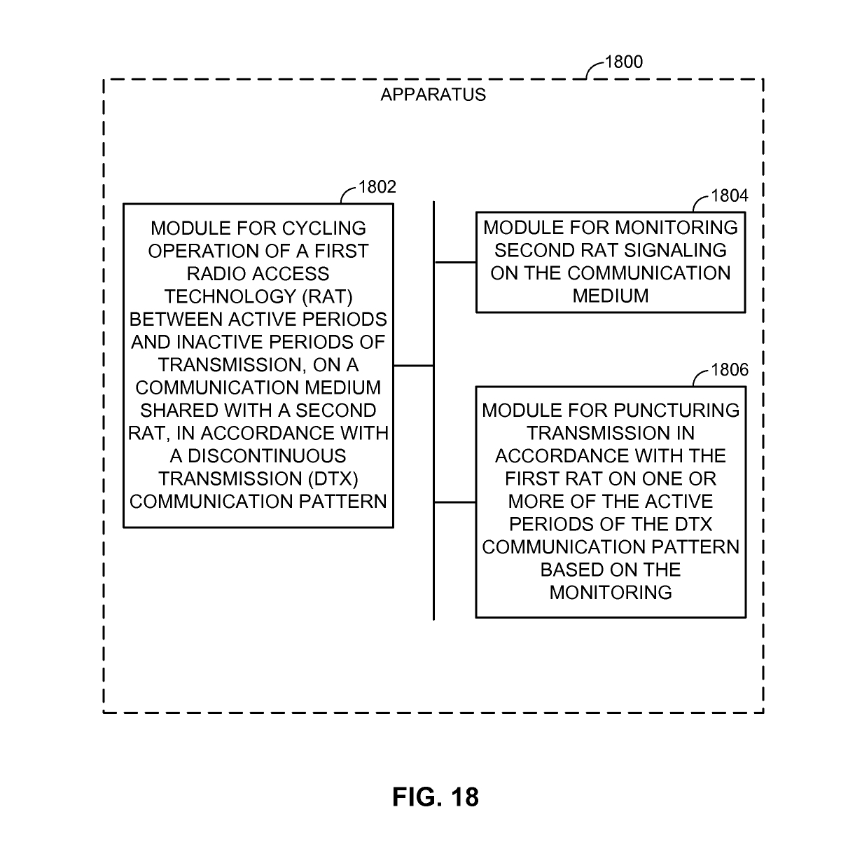

FIG. 18 provide alternative illustrations of apparatuses for implementing the access point 110 and/or the access terminal 120 represented as a series of interrelated functional modules.

FIG. 18 illustrates an example apparatus 1800 represented as a series of interrelated functional modules. A module for cycling 1802 may correspond at least in some aspects to, for example, a communication device or a component thereof as discussed herein (e.g., the communication device 112 or the like). A module for monitoring 1804 may correspond at least in some aspects to, for example, a communication device or a component thereof as discussed herein (e.g., the communication device 112 or the like). A module for puncturing 1806 may correspond at least in some aspects to, for example, a communication controller or a component thereof as discussed herein (e.g., the communication controller 114 or the like).

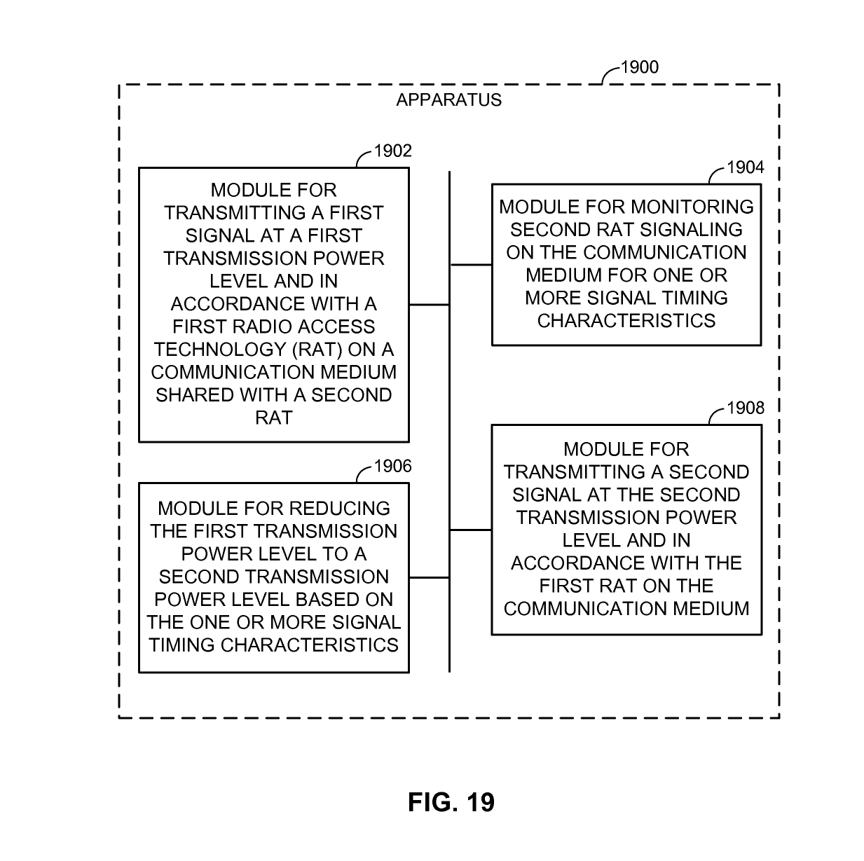

FIG. 19 illustrates an example apparatus 1900 represented as a series of interrelated functional modules. A module for transmitting 1902 may correspond at least in some aspects to, for example, a communication device or a component thereof as discussed herein (e.g., the communication device 112 or the like). A module for monitoring 1904 may correspond at least in some aspects to, for example, a communication device or a component thereof as discussed herein (e.g., the communication device 112 or the like). A module for reducing 1906 may correspond at least in some aspects to, for example, a communication controller or a component thereof as discussed herein (e.g., the communication controller 114 or the like). A module for transmitting 1908 may correspond at least in some aspects to, for example, a communication device or a component thereof as discussed herein (e.g., the communication device 112 or the like).

The functionality of the modules of FIGS. 18-19 may be implemented in various ways consistent with the teachings herein. In some designs, the functionality of these modules may be implemented as one or more electrical components. In some designs, the functionality of these blocks may be implemented as a processing system including one or more processor components. In some designs, the functionality of these modules may be implemented using, for example, at least a portion of one or more integrated circuits (e.g., an ASIC). As discussed herein, an integrated circuit may include a processor, software, other related components, or some combination thereof. Thus, the functionality of different modules may be implemented, for example, as different subsets of an integrated circuit, as different subsets of a set of software modules, or a combination thereof. Also, it will be appreciated that a given subset (e.g., of an integrated circuit and/or of a set of software modules) may provide at least a portion of the functionality for more than one module.

In addition, the components and functions represented by FIGS. 18-19, as well as other components and functions described herein, may be implemented using any suitable means. Such means also may be implemented, at least in part, using corresponding structure as taught herein. For example, the components described above in conjunction with the “module for” components of FIGS. 18-19 also may correspond to similarly designated “means for” functionality. Thus, in some aspects one or more of such means may be implemented using one or more of processor components, integrated circuits, or other suitable structure as taught herein.

It should be understood that any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be employed there or that the first element must precede the second element in some manner. Also, unless stated otherwise a set of elements may comprise one or more elements. In addition, terminology of the form “at least one of A, B, or C” or “one or more of A, B, or C” or “at least one of the group consisting of A, B, and C” used in the description or the claims means “A or B or C or any combination of these elements.” For example, this terminology may include A, or B, or C, or A and B, or A and C, or A and B and C, or 2A, or 2B, or 2C, and so on.

In view of the descriptions and explanations above, one skilled in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Accordingly, it will be appreciated, for example, that an apparatus or any component of an apparatus may be configured to (or made operable to or adapted to) provide functionality as taught herein. This may be achieved, for example: by manufacturing (e.g., fabricating) the apparatus or component so that it will provide the functionality; by programming the apparatus or component so that it will provide the functionality; or through the use of some other suitable implementation technique. As one example, an integrated circuit may be fabricated to provide the requisite functionality. As another example, an integrated circuit may be fabricated to support the requisite functionality and then configured (e.g., via programming) to provide the requisite functionality. As yet another example, a processor circuit may execute code to provide the requisite functionality.

Moreover, the methods, sequences, and/or algorithms described in connection with the aspects disclosed herein may be embodied directly in hardware, in a software module executed by a processor, or in a combination of the two. A software module may reside in Random-Access Memory (RAM), flash memory, Read-only Memory (ROM), Erasable Programmable Read-only Memory (EPROM), Electrically Erasable Programmable Read-only Memory (EEPROM), registers, hard disk, a removable disk, a CD-ROM, or any other form of storage medium known in the art, transitory or non-transitory. An exemplary storage medium is coupled to the processor such that the processor can read information from, and write information to, the storage medium. In the alternative, the storage medium may be integral to the processor (e.g., cache memory).

Accordingly, it will also be appreciated, for example, that certain aspects of the disclosure can include a transitory or non-transitory computer-readable medium embodying a method for communication.

While the foregoing disclosure shows various illustrative aspects, it should be noted that various changes and modifications may be made to the illustrated examples without departing from the scope defined by the appended claims. The present disclosure is not intended to be limited to the specifically illustrated examples alone. For example, unless otherwise noted, the functions, steps, and/or actions of the method claims in accordance with the aspects of the disclosure described herein need not be performed in any particular order. Furthermore, although certain aspects may be described or claimed in the singular, the plural is contemplated unless limitation to the singular is explicitly stated.

What is claimed is:

1. A communication method, comprising:
cycling operation of a first Radio Access Technology (RAT) between active periods and inactive periods of transmission, on a communication medium shared with a second RAT, in accordance with a Discontinuous Transmission (DTX) communication pattern;
monitoring second RAT signaling on the communication medium; and
puncturing transmission in accordance with the first RAT on one or more of the active periods of the DTX communication pattern based on the monitoring.

2. The method of claim 1, the puncturing comprising puncturing in accordance with a puncturing pattern that defines a transmission gap duration and a transmission gap periodicity.

3. The method of claim 2, further comprising setting the transmission gap duration and the transmission gap periodicity based on at least one of:
a latency target for the second RAT;
a signaling energy of the monitored second RAT signaling;
a channel type, primary or secondary, of the monitored second RAT signaling; or
a combination thereof.

4. The method of claim 2, further comprising:
detecting, based on the monitored second RAT signaling, a number of second RAT access points having a signaling energy above a backoff threshold associated with the second RAT; and
setting the transmission gap duration and the transmission gap periodicity based on the number of second RAT access points detected.

5. The method of claim 2, further comprising setting one or more cycling parameters of the DTX communication pattern based on the puncturing pattern.

6. The method of claim 1, the puncturing comprising:
designating one or more subframes for data channel operation with respect to one or more corresponding symbol periods; and
refraining from scheduling data during the one or more corresponding symbol periods.

7. The method of claim 1, the puncturing comprising:
designating one or more subframes for broadcast channel operation to reserve one or more corresponding symbol periods for a multi-cell transmission; and
refraining from transmitting during the one or more corresponding symbol periods.

8. The method of claim 1:
the monitoring comprising measuring a signaling energy associated with the second RAT signaling; and
the puncturing comprising puncturing in response to the measured signaling energy being above a backoff threshold associated with the second RAT.

9. The method of claim 1:
the monitoring comprising detecting latency-sensitive traffic associated with the second RAT signaling; and
the puncturing comprising puncturing in response to the detected latency-sensitive traffic.

10. The method of claim 1:
the communication medium comprising one or more time, frequency, or space resources on an unlicensed radio frequency band;
the first RAT comprising Long Term Evolution (LTE) technology; and
the second RAT comprising Wi-Fi technology.

11. A communication apparatus, comprising:
a first transceiver configured to cycle operation of a first Radio Access Technology (RAT) between active periods and inactive periods of transmission, on a communication medium shared with a second RAT, in accordance with a Discontinuous Transmission (DTX) communication pattern;
a second transceiver configured to monitor second RAT signaling on the communication medium;
at least one processor; and
at least one memory coupled to the at least one processor, the at least one processor and the at least one memory being configured to puncture transmission in accordance with the first RAT on one or more of the active periods of the DTX communication pattern based on the monitoring.

12. The apparatus of claim 11, the at least one processor and the at least one memory being configured to puncture the transmission in accordance with a puncturing pattern that defines a transmission gap duration and a transmission gap periodicity.

13. The apparatus of claim 12, the at least one processor and the at least one memory being further configured to set the transmission gap duration and the transmission gap periodicity based on at least one of:
a latency target for the second RAT;
a signaling energy of the monitored second RAT signaling;
a channel type, primary or secondary, of the monitored second RAT signaling; or
a combination thereof.

14. The apparatus of claim 12, the at least one processor and the at least one memory being configured to:
detect, based on the monitored second RAT signaling, a number of second RAT access points having a signaling energy above a backoff threshold associated with the second RAT; and
set the transmission gap duration and the transmission gap periodicity based on the number of second RAT access points detected.

15. The apparatus of claim 12, the at least one processor and the at least one memory being further configured to set one or more cycling parameters of the DTX communication pattern based on the puncturing pattern.

16. The apparatus of claim 11, the at least one processor and the at least one memory being configured to puncture the transmission by:
designating one or more subframes for data channel operation with respect to one or more corresponding symbol periods; and
refraining from scheduling data during the one or more corresponding symbol periods.

17. The apparatus of claim 11, the at least one processor and the at least one memory being configured to puncture the transmission by:
designating one or more subframes for broadcast channel operation to reserve one or more corresponding symbol periods for a multi-cell transmission; and
refraining from transmitting during the one or more corresponding symbol periods.

18. The apparatus of claim 11, the at least one processor and the at least one memory being further configured to:
measure a signaling energy associated with the second RAT signaling; and
puncture the transmission in response to the measured signaling energy being above a backoff threshold associated with the second RAT.

19. The apparatus of claim 11, the at least one processor and the at least one memory being further configured to:
detect latency-sensitive traffic associated with the second RAT signaling; and
puncture the transmission in response to the detected latency-sensitive traffic.

20. The apparatus of claim 11:
the communication medium comprising one or more time, frequency, or space resources on an unlicensed radio frequency band;
the first RAT comprising Long Term Evolution (LTE) technology; and
the second RAT comprising Wi-Fi technology.

21. A communication apparatus, comprising:
means for cycling operation of a first Radio Access Technology (RAT) between active periods and inactive periods of transmission, on a communication medium shared with a second RAT, in accordance with a Discontinuous Transmission (DTX) communication pattern;
means for monitoring second RAT signaling on the communication medium; and
means for puncturing transmission in accordance with the first RAT on one or more of the active periods of the DTX communication pattern based on the monitoring.

22. The apparatus of claim 21, the means for puncturing comprising means for puncturing in accordance with a puncturing pattern that defines a transmission gap duration and a transmission gap periodicity.

23. The apparatus of claim 22, further comprising means for setting the transmission gap duration and the transmission gap periodicity based on at least one of:
a latency target for the second RAT;
a signaling energy of the monitored second RAT signaling;
a channel type, primary or secondary, of the monitored second RAT signaling; or
a combination thereof.

24. The apparatus of claim 21:
the means for monitoring comprising means for measuring a signaling energy associated with the second RAT signaling; and
the means for puncturing comprising means for puncturing in response to the measured signaling energy being above a backoff threshold associated with the second RAT.

25. The apparatus of claim 21:
the means for monitoring comprising means for detecting latency-sensitive traffic associated with the second RAT signaling; and
the means for puncturing comprising means for puncturing in response to the detected latency-sensitive traffic.

26. A non-transitory computer-readable medium, comprising:
code for cycling operation of a first Radio Access Technology (RAT) between active periods and inactive periods of transmission, on a communication medium shared with a second RAT, in accordance with a Discontinuous Transmission (DTX) communication pattern;
code for monitoring second RAT signaling on the communication medium; and
code for puncturing transmission in accordance with the first RAT on one or more of the active periods of the DTX communication pattern based on the monitoring.

27. The non-transitory computer-readable medium of claim 26, the code for puncturing comprising code for puncturing in accordance with a puncturing pattern that defines a transmission gap duration and a transmission gap periodicity.

28. The non-transitory computer-readable medium of claim 27, further comprising code for setting the transmission gap duration and the transmission gap periodicity based on at least one of:
a latency target for the second RAT;
a signaling energy of the monitored second RAT signaling;
a channel type, primary or secondary, of the monitored second RAT signaling; or
a combination thereof.

29. The non-transitory computer-readable medium of claim 26:
the code for monitoring comprising code for measuring a signaling energy associated with the second RAT signaling; and
the code for puncturing comprising code for puncturing in response to the measured signaling energy being above a backoff threshold associated with the second RAT.

30. The non-transitory computer-readable medium of claim 26:
the code for monitoring comprising code for detecting latency-sensitive traffic associated with the second RAT signaling; and
the code for puncturing comprising code for puncturing in response to the detected latency-sensitive traffic.
